(19) United States
(12) Patent Application Publication
(10) Pub. No.: US 2002/0138364 A1
(43) Pub. Date: Sep. 26, 2002

(54) Method and system for providing additional services for products

(75) Inventors: Hiroyuki Katagiri, Tokyo (JP); Hiroya Kutsuzawa, Tokyo (JP); Masahiro Mikagami, Tokyo (JP); Masahiko Kurashige, Tokyo (JP); Yuko Kameyama, Tokyo (JP); Ken Takumiya, Tokyo (JP); Yasuhiro Kawamura, Tokyo (JP)

Correspondence Address: LADAS & PARRY, 26 WEST 61ST STREET, NEW YORK, NY, 10023, US

(73) Assignee: MEIJI SEIKA KAISHA, LTD

(21) Appl. No.: 10/021,904

(22) Filed: Dec. 13, 2001

(30) Foreign Application Priority Data
Dec. 15, 2000 (JP) 2000-381375

(51) Int. Cl. G06F 17/60

(52) U.S. Cl. 705/26

(57) ABSTRACT

Added values that are suited for use in electronic information media are attached to products. A first identification code ID(A) is attached to a confection x shipped by a confection maker X and a second identification code ID(B) is attached to a toy y shipped by a toy makery. A user who has purchased the products accesses a server device via the Internet from a personal computer or other terminal device and inputs the identification code that was attached to the purchased product. Upon verifying whether or not the identification code that the user has input is correct, the server device carries out the service of providing a game, providing a quiz, providing fortune-telling information, etc. to the terminal device via the Internet. By making the service, which is provided when both ID(A) and ID(B) are input, higher in content and quality in comparison to the service, which is provided when just one of either ID(A) or ID(B) is input, the sales of confection x and toy y are promoted.

### BACKGROUND OF THE INVENTION

This invention concerns a method for attaching added values to products to be distributed in the market and providing additional services based on these added values, and a system for realizing this method. In particular, this invention concerns a technical art by which a game, quiz, fortune-telling information, etc. is provided to a user who has gained access via the Internet using identification codes attached to products.

The method of promoting sales by attaching, in addition to the values that an individual product has inherently, an added value, which is not directly related to the functions of the product, is a classical method that has been used from old and is still used today with various products. For example, such sales methods, as the attaching of a toy as a “freebie” to a confection that is the primary product and, oppositely, the attaching of a confection as a “freebie” to a toy that is the primary product, are still widely used today as typical sales promotion methods. Besides such methods, the methods of attaching a “coupon”, such as a gift certificate or a sweepstake ticket, are also used widely.

As has been mentioned above, the methods of attaching a “freebie” or a “coupon” to a product are sales promotion methods that are adequately effective even today. However, with the spread of personal computers and cellular phones, it is considered that the proportion which the Internet and other new information media take up as fundamentals in social living will increase further and added values to be attached to products must be considered with the use of the Internet and other new electronic information media in mind. In particular, the degree of use of the Internet by younger generations is extremely high, and new forms of sales with added values attached that take the place of “freebies” and “coupons” of prior methods are being demanded for products targeted at such younger generations.

### SUMMARY OF THE INVENTION

This invention has been made to resolve the above problem and an object thereof is to provide an additional service provision method and provision system by which effective promotion of sales can be anticipated through the attachment of added values, which are suited for use in electronic information media, to products.

(1) A first feature of this invention resides in a method for providing additional services for products, wherein added values are attached to products that are distributed in the market and additional services are provided based on these added values, the method comprising:

an identification code attaching step, in which a first identification code is attached to a product that is shipped by a first company and a second identification code is attached to a product that is shipped by a second company,

a server device preparation step, in which a server device, having a first function of separately inputting two types of identification code at the same time or at different times, a second function of confirming that one of the input identification codes is the first identification code and the other is the second identification code, and a third function of providing a predetermined service using a communication device, is prepared, and

a service providing step, in which when the server device is accessed from a terminal device that is operated by a user, the server device is made to execute the first function and thereby made to input identification codes from the terminal device, the server device is made to execute the second function and thereby made to confirm the input identification codes, and under the condition that this confirmation has been obtained, the server device is made to execute the third function and thereby made to provide the predetermined service to the user.

(2) A second feature of this invention resides in a method for providing additional services for products, wherein added values are attached to products that are distributed in the market and additional services are provided based on these added values, the method comprising:

an identification code attaching step, in which a first identification code is attached to a product that is shipped by a first company and a second identification code is attached to a product that is shipped by a second company,

a server device preparation step, in which a server device, having a first function of inputting an identification code, a second function of confirming that the input identification code is either the first identification code or the second identification code, and a third function of selectively providing a service of a first attribute or a service of a second attribute using a communication device, is prepared, and

a service providing step, in which when the server device is accessed from a terminal device that is operated by a user, the server device is made to execute the first function and thereby made to input an identification code from the terminal device, the service device is made to execute the second function and thereby made to confirm the input identification code, and under the condition that the input of one of either the first identification code or the second identification code has been confirmed, the server device is made to execute the third function and thereby made to provide the service of the first attribute to the user, while under the condition that the input of both the first identification code and the second identification code has been confirmed, the server device is made to execute the third function and thereby made to provide the service of the second attribute to the user.

(3) A third feature of this invention resides in a method for providing additional services for products, wherein added values are attached to products that are distributed in the market and additional services are provided based on these added values, the method comprising:

an identification code attaching step, in which a first identification code is attached to a product that is shipped by a first company and a second identification code is attached to a product that is shipped by a second company,

a server device preparation step, in which a server device, having a first function of inputting an identification code, a second function of confirming that the input identification code is either the first identification code or the second identification code, and a third function of selectively providing a service of a first attribute, a service of a second attribute, or a service of a third attribute using a communication device, is prepared, and

a service providing step, in which when the server device is accessed from a terminal device that is operated by a user, the server device is made to execute the first function and thereby made to input an identification code from the terminal device, the server device is made to execute the second function and thereby made to confirm the input identification code, and under the condition that the input of the first identification code has been confirmed, the server device is made to execute the third function and thereby made to provide the service of the first attribute to the user, while under the condition that the input of the second identification code has been confirmed, the server device is made to execute the third function and thereby made to provide the service of the second attribute to the user, and under the condition that the input of both the first identification code and the second identification code has been confirmed, the server device is made to execute the third function and thereby made to provide the service of the third attribute to the user.

(4) A fourth feature of this invention resides in a method for providing additional services for products of any of the above-described first to third features, wherein:

when by the first function of the server device, both the first identification code and the second identification code have been input, the content of the service provided by the third function of the server device is changed according to the order of input of these two types of identification code.

(5) A fifth feature of this invention resides in a method for providing additional services for products of any of the above-described first to fourth features, wherein:

a plurality of patterns are prepared for one of either or both the first identification code and the second identification code and the content of the service provided by the third function of the server device is changed according to the pattern of the identification code that has been input.

(6) A sixth feature of this invention resides in a method for providing additional services for products, wherein added values are attached to products that are distributed in the market and additional services are provided based on these added values, the method comprising:

an identification code attaching step, in which identification codes, each of which is unique to each of n companies, are attached respectively to the products shipped by the n companies,

a server device preparation step, in which a server device, having a first function of separately inputting each of a plurality of types of identification code at the same time or at different times, a second function of confirming that the respective identification codes that have been input are the identification codes of the respective companies, and a third function of providing a predetermined service using a communication device, is prepared, and

a service providing step, in which when the server device is accessed from a terminal device that is operated by a user, the server device is made to execute the first function and thereby made to input identification codes from the terminal device, the server device is made to execute the second function and thereby made to confirm that the identification codes that have been input are the identification codes of all or part of the n companies, and under the condition that this confirmation has been obtained, the server device is made to execute the third function and thereby made to provide the predetermined service to the user.

(7) A seventh feature of this invention resides in a method for providing additional services for products of any of the above-described first to sixth features, wherein:

as a service to be provided by the third function of the server device, the provision of a game, the provision of a quiz, or the provision of fortune-telling information to the terminal device that is operated by the user is carried out.

(8) An eighth feature of this invention resides in a system for providing additional services for products, which has functions of attaching added values to products that are distributed in the market and providing additional services based on these added values, the system is comprised of:

a first identification code generating device, which generates a first identification code,

a second identification code generating device, which generates a second identification code,

a first identification code attaching device, which attaches the first identification code to a product that is shipped by a first company,

a second identification code attaching device, which attaches the second identification code to a product that is shipped by a second company, and

a service providing device, which inputs two different types of identification code separately at the same time or at different times from a user, and upon confirming that one of the identification codes that have been input is the first identification code and the other is the second identification code, provides a predetermined service to the user.

(9) A ninth feature of this invention resides in a system for providing additional services for products, which has functions of attaching added values to products that are distributed in the market and providing additional services based on these added values, the system is comprised of:

a first identification code generating device, which generates a first identification code,

a second identification code generating device, which generates a second identification code,

a first identification code attaching device, which attaches the first identification code to a product that is shipped by a first company,

a second identification code attaching device, which attaches the second identification code to a product that is shipped by a second company, and

a service providing device, which has functions of inputting an identification code from a user and confirming that the identification code that has been input is the first identification code or the second identification code, provides

a service of a first attribute under the condition that one of either the first identification code or the second identification code has been input, and provides a service of a second attribute under the condition that both the first identification code and second identification code have been input.

(10) A tenth feature of this invention resides in a system for providing additional services for products, which has functions of attaching added values to products that are distributed in the market and providing additional services based on these added values, the system is comprised of:

a first identification code generating device, which generates a first identification code,

a second identification code generating device, which generates a second identification code,

a first identification code attaching device, which attaches the first identification code to a product that is shipped by a first company,

a second identification code attaching device, which attaches the second identification code to a product that is shipped by a second company, and

a service providing device, which has functions of inputting an identification code from a user and confirming that the identification code that has been input is the first identification code or the second identification code, provides a service of a first attribute under the condition that the first identification code has been input, provides a service of a second attribute under the condition that the second identification code has been input, and provides a service of a third attribute under the condition that both the first identification code and second identification code have been input.

(11) An eleventh feature of this invention resides in a system for providing additional services for products of any of the above-described eighth to tenth features, wherein:

when both the first identification code and the second identification code have been input from a user, the content of the service provided by the service providing device is changed according to the order of input of the two types of identification code.

(12) A twelfth feature of this invention resides in a system for providing additional services for products of any of the above-described eighth to eleventh features, wherein:

a plurality of patterns are prepared for one of either or both the first identification code and the second identification code, and the content of the service provided by the service providing device is changed according to the pattern of the identification code that has been input.

(13) A thirteenth feature of this invention resides in a system for providing additional services for products of any of the above-described eighth to twelfth features, wherein:

as a service to be provided by the service providing device, the provision of a game, the provision of a quiz, or the provision of fortune-telling information to the user is carried out.

(14) A fourteenth feature of this invention resides in a system for providing additional services for products of any of the above-described eighth to thirteenth features, wherein:

one of either or both the first identification code attaching device and second identification code attaching device has a function of printing the identification code onto the package of a product to be shipped.

(15) A fifteenth feature of this invention resides in a system for providing additional services for products of any of the above-described eighth to thirteenth features, wherein:

one of either or both the first identification code attaching device and second identification code attaching device has a function of adding an object, on which the identification code is printed, inside the package of a product to be shipped.

(16) A sixteenth feature of this invention resides in a system for providing additional services for products of any of the above-described eighth to fifteenth features, wherein:

the service providing device has a function of communicating with the first identification code generating device and the second identification code generating device and is arranged to perform a confirmation process concerning an input identification code by inquiring with the first identification code generating device and the second identification code generating device.

(17) A seventeenth feature of this invention resides in a system for providing additional services for products of any of the above-described eighth to fifteenth features, wherein:

the first identification code generating device and the second identification code generating device have functions of generating the first identification code and the function of generating the second identification code, respectively, based on a predetermined algorithm, and

the service providing device is arranged to perform a confirmation process concerning an input identification code based on the predetermined algorithm.

(18) An eighteenth feature of this invention resides in a system for providing additional services for products of any of the above-described eighth to fifteenth features, wherein:

the service providing device is made of a server device connected to a network and is arranged to input identification codes from terminal devices operated by users via the network and provide services to the terminal devices operated by users via the network.

### BRIEF DESCRIPTION OF THE DRAWINGS

FIG. 1 is a block diagram, which shows the basic arrangement of a system for providing additional services for products of an embodiment of this invention.

FIG. 2 is a diagram, which illustrates the three functions that a service providing device 30 in FIG. 1 has.

FIG. 3 is a diagram, which shows an example of the forms of service provision by the service providing device of FIG. 1.

FIG. 4 is a diagram, which shows modifications of the forms of service provision shown in FIG. 3.

FIG. 5 is a diagram, which shows another modification of a form of service provision shown in FIG. 3.

### DESCRIPTION OF THE PREFERRED EMBODIMENTS

This invention shall now be described based on illustrated embodiments.

1. Basic Arrangement for Putting the Invention into Practice

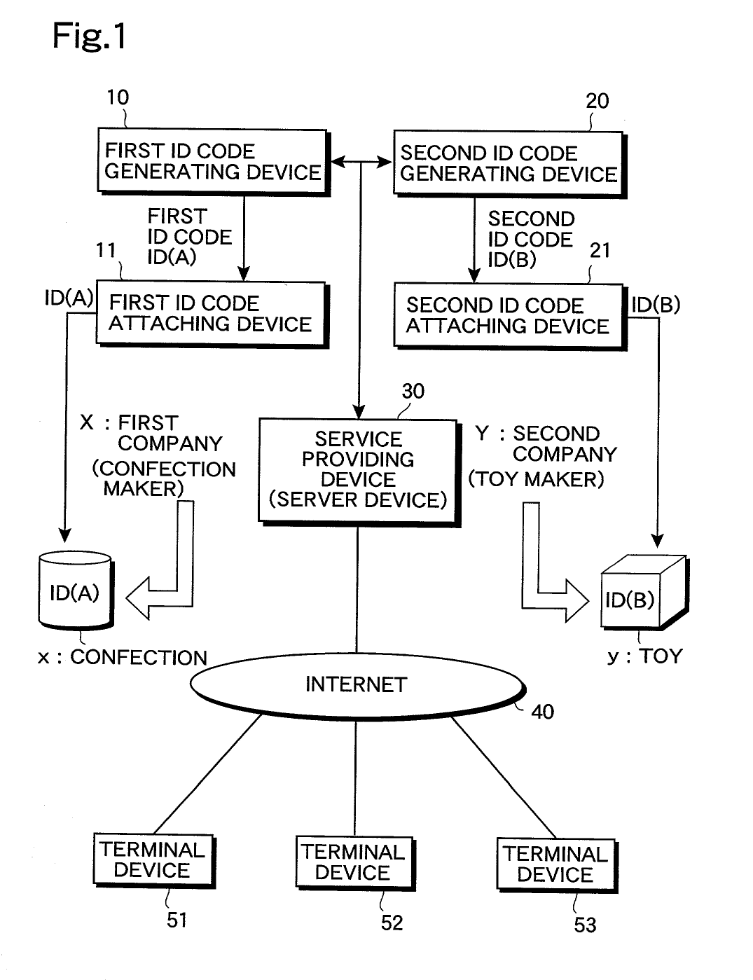

FIG. 1 is a block diagram, which shows the basic arrangement of a system for providing additional services for products of an embodiment of this invention. A characteristic of this system is that in the process of distributing a product x (a confection in the example here) shipped by a first company X (this shall be deemed to be a confection maker for the sake of description here) and a product y (a toy in the example here) shipped by a second company Y (this shall be deemed to be a toy maker for the sake of description here), each product is provided with added value and the provision of additional service is carried out by linkage of the added value provided to the product x with the added value provided to the product

The basic components of this system are a first identification code generating device 10, which generates a first identification code, a second identification code generating device 20, which generates a second identification code, a first identification code attaching device 11, which attaches the first identification code to the product x shipped by the first company X, a second identification code attaching device 21, which attaches the second identification code to the product y shipped by the second company Y, and a service providing device 30, which provides a predetermined service to users.

The identification codes generated by the first identification code generating device 10 and the second identification code generating device 20 maybe any type of code. Generally a code consisting of numerals of several digits or alphabetical characters or a combination thereof may be used. The first identification code is attached to the product x and the second identification code is attached to the product y, and for practical purposes, each identification code that is attached is preferably a unique number that differs for each product. Thus in actuality, it is preferable to take the shipment quantity of the product in consideration and secure an adequate of number of digits for the numerals or alphabetical characters that make up each identification code so that a unique identification code can be attached to each product. Needless to say, in the case of fresh food or other product that will not remain in the distribution process over a long term due to the nature of the product, it is adequate that an arrangement be made to attach unique identification codes to just the products to be shipped within a fixed period. Here, for the sake of description, the identification code that is generated by the first identification code generating device 10 shall be expressed as ID(A) and the identification code that is generated by the second identification code generating device 20 shall be expressed as ID(B). Obviously, identification codes ID(A) and ID(B) respectively differ for each product.

In terms of specifics, the first identification code attaching device 11 may be arranged from any device as long as it has a function of attaching first identification code ID(A), generated by the first identification code generating device 10, to the product x shipped by the first company X. Likewise, in terms of specifics, the second identification code attaching device 21 may be arranged from any device as long as it has a function of attaching second identification code ID(B), generated by the second identification code generating device 20, to the product y shipped by the second company Y. The simplest method of attaching an identification code to a product is a method of printing the identification code onto the package of the product to be shipped. In this case, a printing device for the product package functions as an identification code attaching device 11 or 21, and identification code ID(A) or ID(B) will be printed onto a part of the product package. However, with the method of printing the identification code onto the product package, there is the possibility that the illicit act of jotting down just the identification code and using this identification code without buying the product at a store will be carried out. Thus for practical purposes, measures, such as printing the identification code onto a location that will not be visible unless the package is opened or providing a packaging material that will cover a part on which the identification code has been printed, will be necessary. Besides the above, a printed object on which an identification code ID(A) or ID(B) is indicated may be prepared separately from the product package and this identification code printed object may be added inside the product package. In this case, a printing device for preparing the printed object and a device for packaging this printed object along with the product function as an identification code attaching device 11 or 21. A character card or other so-called “freebie” may for example be used as a printed object on which the identification code is printed.

The basic concept of this invention lies in the point of distributing a product x (confection), to which first identification code ID(A) has been attached as described above, and a product y (toy), to which second identification code ID(B) has been attached, in the market and providing additional service to a user who has bought both products. Though various methods can be considered as a method of providing the additional service, the present inventor considers that a method that makes use of the Internet is the most effective method. Thus as the embodiment described here, an example wherein the service providing device 30 provides a predetermined service to a user using the Internet 40 shall be described. Thus with the embodiments described here, a user who is to receive the service must have an environment for connecting to Internet 40. Each of the illustrated terminal devices 51 to 53 (actually, plenty of terminal devices are connected to Internet 40) is a terminal device that is operated by a user to connect to Internet 40, and to be more specific, is comprised of a personal computer or cellular phone, etc. Meanwhile, the service providing device 30 is arranged from a server device that is connected to Internet 40. In general, the service providing device 30 is arranged from a web server device so as to enable access to the service providing device 30 by use of a web browser installed in each of the terminal devices 51 to 53.

The procedure for a certain user to receive a provision of service from the service providing device 30 by use of the terminal device 51, after he/she purchases both the product x and the product y, shall now be described. The user first uses the web browser function of the terminal device 51 to access a predetermined web page that the service providing device 30 (web server device) has made public on Internet 40. The information necessary for such access, that is, an URL address of the relevant web page, can be indicated on the packages or instruction manuals of the product x and the product y.

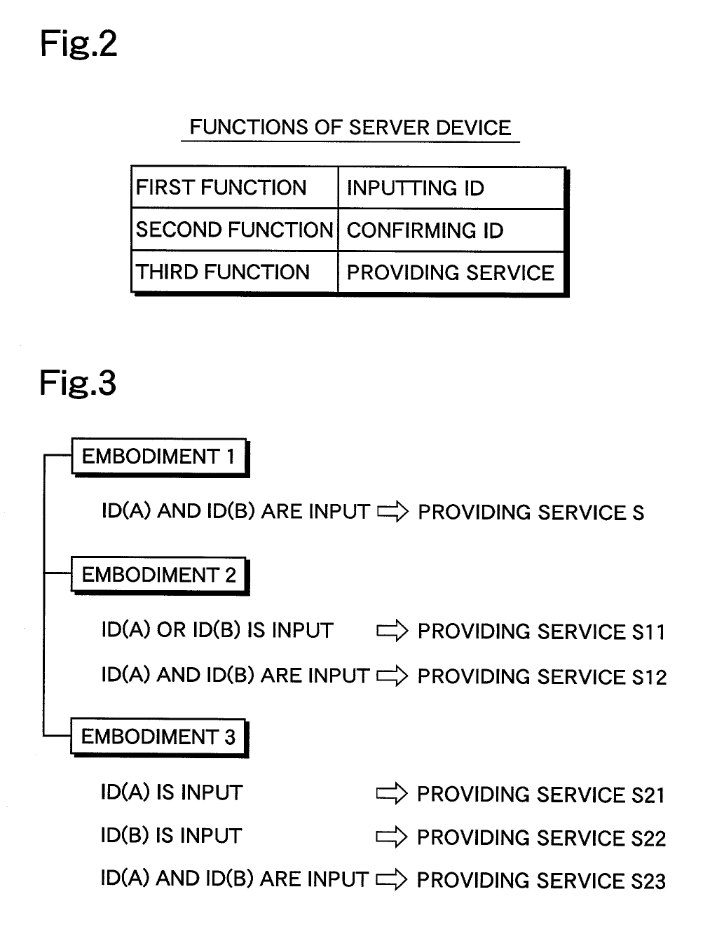

As shown in FIG. 2, the server device 30 has three functions. The first function is the identification inputting function, which is a function of taking in an identification code that has been input from the terminal device 51 via Internet 40. A user carries out an operation of inputting, in accordance to instructions on the web page provided by the server device 30, the identification code attached to the product x or the product y from the terminal device 51.

The second function is the identification code confirmation function, which is a function of confirming whether or not the identification code that has been taken in by the above-described first function is the first identification code ID(A) that has been generated by the first identification code generating device 10 and whether or not the identification code that has been taken in is the second identification code ID(B) that has been generated by the second identification code generating device 20. With the embodiment shown in FIG. 1, the server device 30 has a function of communicating with the first identification code generating device 10 and the second identification code generating device 20 (though an example where communication is performed by a communication device that is separate that for Internet 40 is shown in FIG. 1, this communication may be performed via Internet 40 as well) and can perform the confirmation process concerning the input identification code by inquiring with the first identification code generating device 10 and the second identification code generating device 20. In this case, each of the first identification code generating device 10 and the second identification code generating device 20 is arranged to record and store identification codes that have been issued in the past, to reference the records of the past when an inquiry concerning a specific identification code is made by the server device 30, and to reply whether or not the identification code is an identification code that has been issued in the past. Based on this reply, the server device 30 can confirm whether or not the identification code that has been input by the user is the first identification code ID(A) and whether or not the identification code that has been input is the second identification code ID(B).

The second function of the server device 30 does not necessarily have to be carried out based on an inquiry with the first identification code generating device 10 or the second identification code generating device 20. For example, in the case where the first identification code generating device 10 and the second identification code generating device 20 have functions of generating a first identification code ID(A) and a second identification code ID(B), respectively, based on a predetermined algorithm, the server device 30 may be arranged to perform, based on this predetermined algorithm, the process of confirming whether or not the identification code that has been input by the user is the first identification code ID(A) that has been generated by the first identification code generating device 10 and whether or not the identification code that has been input is the second identification code ID(B) that has been generated by the second identification code generating device 20. For example, if an algorithm that generates an identification code by applying a specific operation to a specific secret code is used (the secret code or algorithm is made to differ for the first identification code generating device 10 and the second identification code generating device 20), it can be verified whether or not an identification code has been generated based on the specific secret code and the specific algorithm. In such a case, the verification process can be performed in the server device 30 to confirm whether or not the identification code that has been input by the user is the first identification code ID(A) and whether or not the identification code that has been input is the second identification code ID(B) without making an inquiry to the first identification code generating device 10 or to the second identification code generating device 20.

The third function of the server device 30 is a service providing function. The service that is to be provided may be any form of service as long as it is a service for the user. However, with the embodiment described here, since the service providing device 30 is arranged from a web server device that is connected to Internet 40, the service for the user is preferably a service that can be provided to the terminal device 51 by the use of Internet 40. Service, such as the provision of a game, provision of a quiz, or provision of fortune-telling information to the user for example is suitable for provision using Internet 40. The specific contents of such service shall be described in the form of examples below.

2. Forms of Provision of Service

As has been described above, a provision of service, which is carried out as the third function of the server device 30, is carried out in accordance to the result of the identification code confirmation that has been carried out as the second function. That is, the provision of service, such as the provision of a game, provision of a quiz, or provision of fortune-telling information to a user, is carried out under the condition that the identification code that has been input by the user has been confirmed, and no provision of service whatsoever is carried out if the user had input a meaningless identification code. In order to receive a provision of service, a user must input a correct identification code that has been attached to a product. Such a method for providing service under the condition of input of a correct identification code can prevent one that has not purchased a product from receiving the provision of service by illicit means and is beneficial from the standpoint of copyright protection as well. With regard to putting the present invention into practice, there are two types of correct identification code, the first identification code ID(A) and the second identification code ID(B). Though several ways of handling are possible with regard to what services are provided according to which identification code is input, basically, the three types of embodiment shown in FIG. 3 can be considered.

With the embodiment 1 shown in FIG. 3, a predetermined service S is provided only when the first identification code ID(A) and the second identification code ID(B) are input from a user. That is, the service S is provided only in the case where the AND condition of ID(A) and ID(B) is met, and the service is not provided in other cases. With the example shown in FIG. 1, since ID(A) is the identification code that is attached to the product x (confection) and ID(B) is the identification code that is attached to the product y (toy), only a user that has purchased both the confection and the toy (only a user that has been able to obtain both ID(A) and ID(B)) can receive the provision of service S. For practical purposes, the first company X, which is a confection maker, and the second company Y, which is a toy maker, carry out, in a cooperative manner, a sales promotion campaign indicating that a game, a quiz, fortune telling, etc. can be enjoyed on the Internet when the specific confection and specific toy to which the campaign applies are purchased. A user who has purchased only the confection can only obtain the first identification code ID(A) and will thus want to purchase the toy in order to obtain the second identification code ID(B), and oppositely, a user who has purchased only the toy can only obtain the second identification code ID(B) and will thus want to purchase the confection in order to obtain the first identification code ID(A). A merit of this invention is that effective sales promotion can be realized through the mutual linkage of a plurality of different companies.

When this embodiment 1 is to be employed, the server device 30 performs the processes of inputting, by the first function, two different types of identification code from a user, confirming, by the second function, that one of these input identification codes is the first identification code ID(A) and the other is the second identification code ID(B), and providing, under the condition that this confirmation is obtained and by the third function, the service S to the user by use of Internet 40.

With the above-described embodiment 1, no service whatsoever is provided to a user who has purchased just the product x (confection) or a user who has purchased just the product y (toy) . This is because the premise for receiving service S has been set to the condition that the input of both the first identification code and the second identification code, in other words, ID(A) AND ID(B) has been performed. However, it is considered that, in actuality, the number of cases where just one of the products is bought at first will be overwhelmingly greater than the number of cases where the product x (confection) and the product y (toy) are purchased at the same time. Thus for practical purposes, it is preferable that some form of service provision be obtainable even when just one of the identification codes has been acquired.

The embodiment 2, which is shown in FIG. 3, is an embodiment based on such a standpoint, and with this embodiment, when one of either the first identification code ID(A) or second identification code ID(B) has been input from a user, the service S11 of the first attribute is provided and when both codes have been input, the service S12 of the second attribute is provided. Here, the service S11 of the first attribute and the service S12 of the second attribute are services that differ in content and quality as shall be illustrated by examples below, and in general, the service S12 of the second attribute is made higher in content and quality. Thus when the OR condition of ID(A) OR ID(B) is met, the provision of the service S11 of the first attribute can be obtained, and when the AND condition of ID(A) AND ID(B) is met, the provision of the service S12 of the second attribute, which is more substantiated in content and quality, can be obtained. With such an embodiment, though a user who has purchased only the confection or a user who has purchased only the toy can receive, for the time being, the provision of service S11 of the first attribute, by this receiving of the provision of service S11 of the first attribute, the user is made to want to receive the provision of service S12 of the second attribute, which is further substantiated in content and quality. An adequate sales promotion effect can thus be obtained.

In the case where this embodiment 2 is to be employed, the server device 30 performs the processes of inputting, by the first function, an identification code from a user, confirming, by the second function, whether this input identification code is the first identification code ID(A) or the second identification code ID(B), and providing, by the third function and in accordance to the confirmation result, the service S11 of the first attribute to the user by use of Internet 40 in the case where one of either the first identification code ID(A) or the second identification code ID(B) has been input and the service S12 of the second attribute to the user by use of Internet 40 in the case where both the first identification code ID(A) and the second identification code ID(B) have been input.

Embodiment 3 shown in FIG. 3 is an embodiment by which the above-described embodiment 2 has been developed further. That is, whereas with the above-described embodiment 2, when one of either the first identification code ID(A) or the second identification code ID(B) has been input the service S11 of the first attribute is provided in either case, with this embodiment 3, when the first identification code ID(A) has been input, the service S21 of the first attribute is provided, when the second identification code ID(B) has been input, the service S22 of the second attribute is provided, and when both the identification codes ID(A) and ID(B) have been input, the service S23 of the third attribute is provided. Here, the service S21 of the first attribute, the service S22 of the second attribute, and the service S23 of the third attribute are services that differ mutually in content and quality, and generally, the quality of the service S21 of the first attribute and the service S22 of the second attribute can be approximately the same and the service S23 of the third attribute is made higher in content and quality in comparison to the other services.

In the case where this embodiment 3 is to be employed, the server device 30 performs the processes of inputting, by the first function, an identification code from a user, confirming, by the second function, whether this input identification code is the first identification code ID(A) or the second identification code ID(B), and providing, by the third function and in accordance to the confirmation result, the service S21 of the first attribute to the user by use of Internet 40 in the case where the first identification code ID(A) has been input, the service S22 of the second attribute to the user by use of Internet 40 in the case where the second identification code ID(B) has been input, and the service S23 of the third attribute to the user by use of Internet 40 in the case where both the first identification code ID(A) and the second identification code ID(B) have been input.

For practical purposes, it is preferable to set a limit in the number of times a service is provided upon input of the same identification code. For example, in the case of embodiment 3, if the number of times of service which is provided for the same identification code is limited to three, the provision of service S21 can be obtained up to three times in correspondence to the input of the same identification code ID(A), the provision of service S22 can be obtained up to three times in correspondence to the input of the same identification code ID(B), and the provision of service S23 can be obtained up to three times in correspondence to the input of the same identification codes ID(A) and ID(B) . By setting such a limit in the number of times, a user is made to want to purchase a new product again to obtain a new identification code when the limit in the number of times of service provision is reached. An adequate sales promotion effect can thus be obtained. In the case where such a limit in the number of times is to be set, an arrangement for counting how many times a certain service has been provided for the input of a certain identification code may be provided inside the server device 30.

With each of the above-described embodiments, in the case where a predetermined service is to be provided under the premise that an AND condition, such as ID(A) and ID(B), is met, there is no need for the first identification code ID(A) and the second identification code ID(B) to be input simultaneously, and as long as it can be confirmed that the two identification codes have been input from the same terminal device 51 (or another terminal device operated by the same user), there can be a separation in the timing at which the identification codes have been input. For example, if in the case where the above-described embodiment 3 is put into practice, a user, who has purchased only the confection, performs access using first identification code ID(A), the user can receive the provision of service S21. If an arrangement is made to record that there was an access using this identification code ID(A) from the particular user in this process, it can be recognized at a later date when there is an access from the same user again that the input of the identification code ID(A) has already been completed for this particular user. Thus when this particular user purchases the toy, acquires the second identification code ID(B), and performs access using this identification code ID(B) on a later date, this particular user will not only be able to obviously receive the provision of service S22 but since it can be confirmed that for this user, both the first identification code ID(A) and the second identification code ID(B) have been input with a time difference, the user will also be able to receive the provision of service S23.

In putting the present invention into practice, by arranging the history of access from individual users to be recorded, a service usage history can be prepared for each user, thus enabling acquisition of such information as how frequently the products x and y are purchased, which services are being received, and at which time ranges the services are being received for each individual user, and such information can be referenced for carrying out other sales promotion campaigns. Also, since information in the form of the identification code attached to each product is returned via Internet 40, control of the distribution history is also enabled. For example, if an arrangement is made to record information on which identification code was attached to a product that was shipped on such and such a date, it becomes possible to ascertain when a product that was shipped at a certain period will reach the hands of a user, that is, ascertain the retention time of a product in the distribution process. Also, by making the attached identification code distinguishable according to the shipment district, for example, by making the identification code to be attached to a product to be shipped to an East Coast district and the identification code to be attached to a product to be shipped to an West Coast district different, information such as “which district users are high in the frequency of use of services” can also be obtained.

3. Various Modifications

Some modifications of the embodiments that have been described above shall now be described.

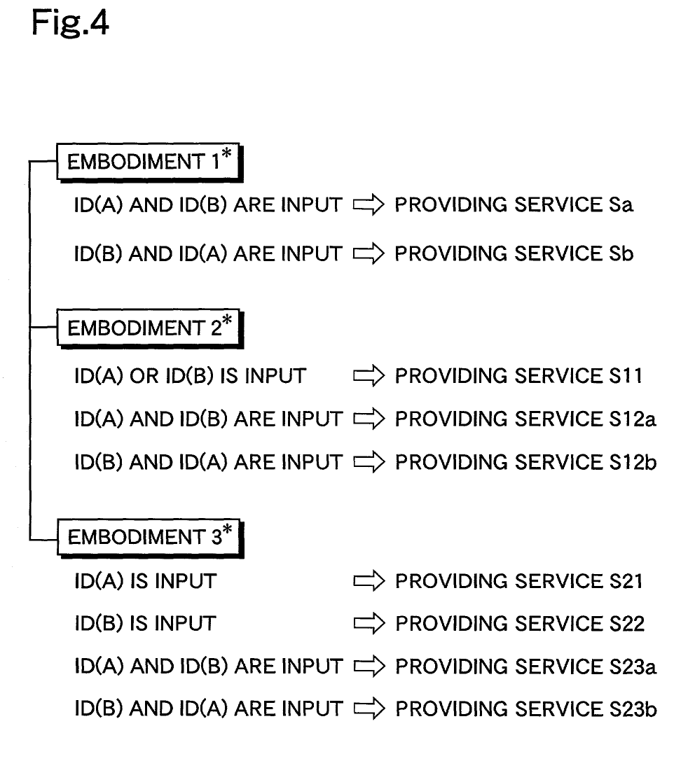

(1) The embodiments 1*, 2*, and 3* shown in FIG. 4 are modifications of the embodiments 1, 2, and 3, respectively, shown in FIG. 3, and with each of these modifications, in the case where both the first identification code ID(A) and the second identification code ID(B) have been input from a user, the content of the service to be provided is changed according to the order of input of these two types of identification code. For example, in the case of embodiment 1*, service Sa is provided when the two identification codes were input in the order of ID(A), ID(B), and when the identification codes were input in the opposite order of ID(B), ID(A), service Sb is provided. In the case of embodiment 2*, service S12a is provided when the two identification codes were input in the order of ID(A), ID(B), and when the identification codes were input in the opposite order of ID(B), ID(A), service S12b is provided. Likewise in the case of embodiment 3*, service S23a is provided when the two identification codes were input in the order of ID(A), ID(B), and when the identification codes were input in the opposite order of ID(B), ID(A), service S23b is provided. By thus changing the service to be provided based on the order of input of a plurality of identification codes, services can be provided in a manner that is richer in variation.

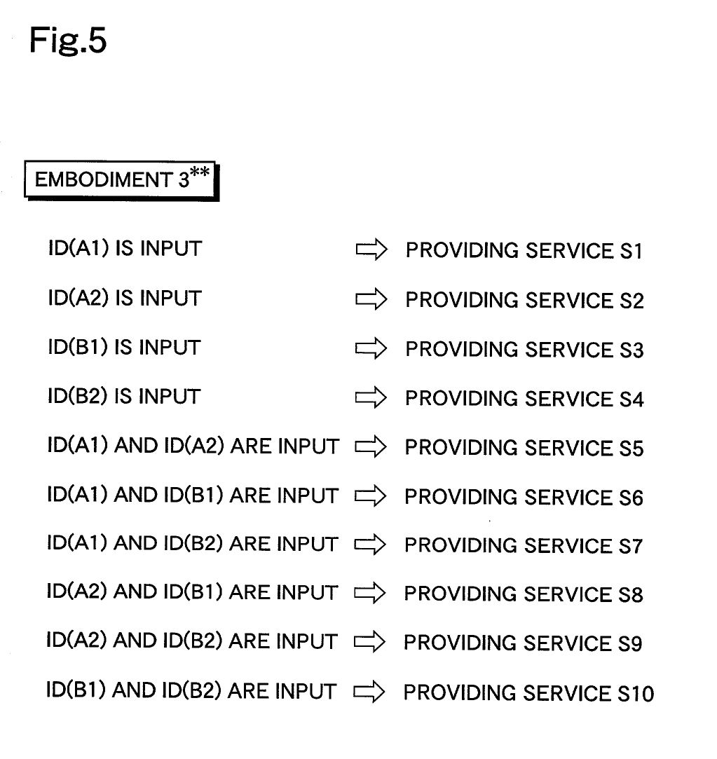

(2) The embodiment 3** shown in FIG. 5 is another modification of the embodiment 3 shown in FIG. 3, and with this modification, a plurality of patterns are prepared for each of the first identification code ID(A) and the second identification code ID(b) and the content of the service that is provided is changed according to the pattern of the identification code that has been input. With the illustrated example, the two patterns of ID(A1) and ID(A2) are prepared for the first identification code ID(A) and an identification code that is actually attached to the product x will belong to one of either of these two patterns. Likewise, the two patterns of ID(B1) and ID(B2) are prepared for the second identification code ID(B) and an identification code that is actually attached to the product y will belong to one of either of these two patterns. By thus preparing a plurality of patterns for each of the first identification code and the second identification code, the service to be provided can be changed in various ways according to the various combinations of the patterns, thus enabling the provision of services that are rich in variation. With the example shown in FIG. 5, a service selected from among the ten different services of service S1 to S10 can be provided according to the various combinations. Needless to say, in the case where two identification codes are input, the variation can be increased further by changing the content of the service further according to the order of input. In the case where a plurality of patterns are prepared, identification codes that differ mutually can be attached according to each individual product or according to each product group of a common price range to provide variation to the added value attached according to product.

(3) With the arrangement illustrated in the block diagram of FIG. 1, the functions of the system by this invention are noted and this system is illustrated by means of functional blocks. An actual device arrangement is therefore not indicated. Thus though with the illustrated arrangement example, the first identification code generating device 10 and the first identification code attaching device 11 are separate components and the second identification code generating device 20 and the second identification code attaching device 21 are separate components, device 10 and device 11 may be arranged as a single device and device 20 and device 21 may be arranged as a single device. Also, the first identification code generating device 10 and the second identification code generating device 20 may be arranged from the same device (for example, the same computer), and furthermore, these devices 10 and 20 may be incorporated inside the service providing device 30 (for example, the same server device).

(4) With the above-described embodiments, the attachment of the respective identification codes to the products is performed by printing numerals, characters, etc. onto a product package or by packaging an object, on which numerals, characters, etc. have been printed, inside the product package along with the product, and a user operates a terminal device to input such an identification code that has been attached to a product in a visually recognizable form. However, a visually recognizable form does not have to be employed as a means of attaching an identification code to a product. For example, an identification code may be attached to a product in the form of a bar code or attached to a product in the form of a record in a magnetic recording medium or optical recording medium. In this case, a user will perform the operation of inputting the identification code into the terminal device using a bar code reader or a data reading device for the corresponding recording medium.

(5) Though with the above-described embodiments, the input of identification code and the provision of service are carried out via the Internet, the Internet does not have to be used necessarily in putting this invention into practice. For example, a personal computer, cellular phone, game equipment, etc. that a user him/herself owns may be used as service providing device 30. To be more specific, a predetermined software may be distributed to the respective users by such methods as distribution of CD-ROM's or other media, downloading from the Internet, etc. and by having the user incorporate this software in a personal computer, etc. owned by the user, the personal computer itself may be made to function as the service providing device 30. In this case, a user performs the operation of inputting the identification code directly into the service providing device 30 (the personal computer) and will receive the provision of service directly from the service providing device 30.

(6) Though with the above-described embodiments, the present invention is put into practice for two companies, this invention is characterized in that identification codes, each of which is unique to each of a plurality of companies, are arranged to be respectively attached to products shipped by the respective companies to enable a campaign to be developed in common by a plurality of companies, and the number of companies participating in this campaign does not necessarily have to be two. That is, three or more companies may develop a campaign in common and each company may attach its own unique identification code to a product. In this case, the provision of service to a user may be carried out under the condition that the identification codes of all companies participating in the campaign have been input or may be carried out under the condition that identification codes of just a part of the companies have been input. Needless to say, the content of the service that is provided may be changed according to the number and types of the identification codes that have been input.

4. More Specific Examples

Lastly, more specific examples of the embodiment shown in FIG. 1, which uses the Internet, shall be described. The following examples concern the above-described embodiments 3, 3*, and 3**, and thus concern embodiments with which a user, who has purchased a confection and a toy, uses a personal computer as the terminal device 51 to access the server, which is the service providing device 30, and inputs the identification codes attached to the products to receive such services as the provision of a game, provision of a quiz, or provision of fortune-telling information, etc. The provision of a game, provision of a quiz, or provision of fortune-telling information, etc. are thus carried out as “electronic freebies” attached to the products.

(1) Basic concept: different worlds are developed with 10 the two identification codes. With this service, though a certain stage can be experienced with just one identification code, by acquiring two identification codes and experiencing two stages, a third stage may be entered. For example, the experience of stage X (service of the first attribute) can be obtained by the input of identification code ID(A), the experience of stage Y (service of the second attribute) can be obtained by the input of identification code ID(B), and the experience of stage Z (service of the third attribute) can be obtained by clearing both of the above stages.

To give a more specific example, a character rearing simulation game, for enjoying the growth process of a game character, is provided. When identification code ID(A) is input, the service of the first attribute, that is, a rearing simulation game of the stage in which the game character goes to school is provided, and when identification code ID(B) is input, the service of the second attribute, that is, a rearing simulation game of the stage in which the game character gets employed by a company is provided. And when both the school stage and company stage are cleared (obviously, both identification codes ID(A) and ID(B) will have been input by then), the rearing simulation game of the living stage is provided (service of the third attribute). When this living stage is entered, yet another identification code ID(C) is provided and by inputting this identification code ID(C), the simulation of carrying out business in a virtual reality urban space is enabled and communication with other players becomes possible.

Or a quiz game may be provided. That is, when identification code ID(A) is input, the service of the first attribute is provided, that is, quizzes of an across-the-nation gourmet genre are given and when identification code ID(B) is input, the service of the second attribute is provided, that is, quizzes of an across-the-nation transportation genre are given. When the quizzes from these two genres have been given or these quizzes are answered at a certain percentage of correctness (obviously, both identification codes ID(A) and ID(B) will have been input by then), quizzes that accompany a present are given (service of the third attribute) and if the percentage of correctness is high for these quizzes, a present can be obtained. Or, yet another identification code ID(C), which is required in order to tackle more quizzes, is provided.

(2) Basic concept: a single object is built up using two identification codes. For example, the creation of a part X (service of the first attribute) is enabled by the input of identification code ID(A), the creation of a part Y (service of the second attribute) is enabled by the input of identification code ID(B), and the creation of a single object (service of the third attribute) is enabled by the synthesis of parts X and Y.

To give a more specific example, a character rearing simulation game, for enjoying the growth process of a game character, is provided. When identification code ID(A) is input, the service of the first attribute is provided, that is, entry into a brain forming stage is enabled and the setting of various brain parameters of the character is enabled. When identification code ID(B) is input, the service of the second attribute is provided, that is, entry into a body forming stage is enabled and the setting of various body parameters of the character is enabled. By combining the brain and body parameters of the character in a well-balanced manner (obviously, both identification codes ID(A) and ID(B) will have been input by then), an original character can be completed (service of the third attribute). A completed original character is ranked and a special option, such as appearance in an animation program, etc., is provided for a highly ranking character.

(3) Basic concept: the chances of passing are increased with two identification codes. For example, the tackling of quizzes of a genre X (service of the first attribute) is enabled by the input of identification code ID(A), the tackling of quizzes of a genre Y (service of the second attribute) is enabled by the input of identification code ID(B), and passing (service of the third attribute) can be achieved according to the answers to the quizzes of both genres X and Y.

To be more specific, a quiz game with prize is provided. That is, when identification code ID(A) is input, the service of the first attribute is provided, that is, quizzes of an across-the-nation gourmet genre are given and when identification code ID(B) is input, the service of the second attribute is provided, that is, quizzes of an across-the-nation transportation genre are given. When the total number of correctly answered quizzes exceeds 50, a prize can be obtained. In the case where the number of correctly answered quizzes of the across-the-nation gourmet genre is 40 and the number of correctly answered quizzes of the across-the-nation transportation genre is 30, though a prize cannot be acquired with just one of the identification codes, by acquiring both identification codes, the total number of correctly answered quizzes will be 70, thus enabling the acquisition of the prize (service of the third attribute).

(4) Basic concept: a participation right and relevant information can be acquired with two identification codes. The right to participate in some game is obtained by one identification code and acquisition of relevant information concerning the same game is enabled by the other identification code. For example, the participation right X for a game is obtained (service of the first attribute) by the input of identification code ID(A), relevant information Y is obtained (service of the second attribute) by the input of identification code ID(B), and by acquiring both the participation right X and relevant information Y, the object of the game can be cleared (service of the third attribute) and furthermore, entry into the next stage is enabled.

(5) Basic concept: use of all functions is enabled only with two identification codes. Though only a part of the functions can be used with just one of the identification codes, the use of all functions is enabled with both identification codes. For example, for services that enable communication with another user, the functions of listing one's messages on a personal page and viewing another person's personal page are obtained (service of the first attribute) by the input of identification code (A), the function of sending one's own opinions to another person's personal page is obtained (service of the second attribute) by the input of identification code ID(B), and all functions are obtained (service of the third attribute) by the input of both identification codes ID(A) and ID(B). Or, an auction site may be provided, and the placing of an object in the auction may be enabled by one of the identification codes, the purchasing of an object in the auction may be enabled by the other identification code, and placing and purchasing may be enabled by both identification codes.

(6) Basic concept: the development is changed according to the combination of a plurality of identification code patterns. A plurality of patterns are prepared for identification codes ID(A) and ID(B) and different services are provided according to their combinations. For example, in a role playing game (RPG), playing in stage 1 is enabled by the input of ID(A1), playing in stage 2 is enabled by the input of ID(A1) and ID(A2), playing in stage 3 is enabled by the input of ID(B1), playing in stage 4 is enabled by the input of ID(B1) and ID(B2), and playing in stage 5 is enabled by the input of ID(A1), ID(A2), ID(B1), and ID(B2).

(7) Basic concept: the development is changed according to the order of input of the identification codes. For example in an RPG, playing in stage 1 is enabled by the input of ID(A), playing in stage 2 is enabled by the input of ID(B), playing in stage 3 is enabled by the input of two identification codes in the order, ID(A) ID(B), and playing in stage 4 is enabled by the input of two identification codes in the order, ID(B) ID(A). Or the identification code itself may be provided with a “hit/miss” attribute and the experiencing of a stage may be disabled in the case of an identification code with a “miss” attribute.

(8) Basic concept: a plurality of identification code patterns are prepared and a result is judged according to the combination of patterns. For example, a result 1 is indicated for combination of ID(A1) and ID(B1), a result 2 is indicated for a combination of ID(A1) and ID(B2), a result 3 is indicated for a combination of ID(A2) and ID(B1), and a result 4 is indicated for a combination of ID(A2) and ID(B2).

To be more specific, an affinity augury game is provided. For the combination, ID(A1) and ID(B1), the “Too bad. This is the worst match.” result is indicated. For the ID(A1) and ID(B2) combination, the “Good luck will come with effort.” result is indicated. For the ID(A2) and ID(B1) combination, the “So-so.” result is indicated. For the ID(A2) and ID(B2) combination, the “Best match.” result is indicated.

As has been described above with the method and system for providing additional services for products by this invention, added values, which are suited for use in electronic information media, can be attached in the form of so-called “electronic freebies” to products and more effective sales promotion is enabled through the linkage of a plurality of companies.

What is claimed is:

1. A method for providing additional services for products, wherein added values are attached to products that are distributed in a market and additional services are provided based on the added values, the method comprising:
an identification code attaching step, in which a first identification code is attached to a product that is shipped by a first company and a second identification code is attached to a product that is shipped by a second company,
a server device preparation step, in which a server device, having a first function of separately inputting two types of identification code at a same time or at different times, a second function of confirming that one of the input identification codes is said first identification code and the other is said second identification code, and a third function of providing a predetermined service using a communication device, is prepared, and
a service providing step, in which when said server device is accessed from a terminal device that is operated by a user, said server device is made to execute said first function and thereby made to input identification codes from said terminal device, said server device is made to execute said second function and thereby made to confirm the input identification codes, and under a condition that a confirmation has been obtained, said server device is made to execute said third function and thereby made to provide said predetermined service to said user.

2. A method for providing additional services for products, wherein added values are attached to products that are distributed in a market and additional services are provided based on the added values, the method comprising:
an identification code attaching step, in which a first identification code is attached to a product that is shipped by a first company and a second identification code is attached to a product that is shipped by a second company,
a server device preparation step, in which a server device, having a first function of inputting an identification code, a second function of confirming that an input identification code is either said first identification code or said second identification code, and a third function of selectively providing a service of a first attribute or a service of a second attribute using a communication device, is prepared, and
a service providing step, in which when said server device is accessed from a terminal device that is operated by a user, said server device is made to execute said first function and thereby made to input an identification code from said terminal device, said server device is made to execute said second function and thereby made to confirm an input identification code, and under a condition that an input of one of either said first identification code or said second identification code has been confirmed, said server device is made to execute said third function and thereby made to provide a service of said first attribute to said user, while under a condition that an input of both said first identification code and said second identification code has been confirmed, said server device is made to execute said third function and thereby made to provide a service of said second attribute to said user.

3. A method for providing additional services for products, wherein added values are attached to products that are distributed in a market and additional services are provided based on the added values, the method comprising:
an identification code attaching step, in which a first identification code is attached to a product that is shipped by a first company and a second identification code is attached to a product that is shipped by a second company,
a server device preparation step, in which a server device, having a first function of inputting an identification code, a second function of confirming that an input identification code is either said first identification code or said second identification code, and a third function of selectively providing a service of a first attribute, a service of a second attribute, or a service of a third attribute using a communication device, is prepared, and
a service providing step, in which when the server device is accessed from a terminal device that is operated by a user, said server device is made to execute said first function and thereby made to input an identification code from said terminal device, said server device is made to execute said second function and thereby made to confirm an input identification code, and under a condition that an input of said first identification code has been confirmed, said server device is made to execute said third function and thereby made to provide a service of said first attribute to said user, while under a condition that an input of said second identification code has been confirmed, said server device is made to execute said third function and thereby made to provide a service of said second attribute to said user, and under a condition that an input of both said first identification code and said second identification code has been confirmed, said server device is made to execute said third function and thereby made to provide a service of said third attribute to said user.

4. A method for providing additional services for products as set forth in claim 1, wherein:
when by the first function of the server device, both the first identification code and the second identification code have been input, a content of a service provided by the third function of the server device is changed according to an order of input of the two types of identification code.

5. A method for providing additional services for products as set forth in claim 1, wherein:
a plurality of patterns are prepared for one of either or both the first identification code and the second identification code and the content of the service provided by the third function of the server device is changed according to the pattern of the identification code that has been input.

6. A method for providing additional services for products, wherein added values are attached to products that are distributed in a market and additional services are provided based on the added values, the method comprising:
an identification code attaching step, in which identification codes, each of which is unique to each of n companies, are attached respectively to the products shipped by the n companies,
a server device preparation step, in which a server device, having a first function of separately inputting each of a plurality of types of identification code at a same time or at different times, a second function of confirming that respective identification codes that have been input are said identification codes of said respective companies, and a third function of providing a predetermined service using a communication device, is prepared, and
a service providing step, in which when said server device is accessed from a terminal device that is operated by a user, said server device is made to execute said first function and thereby made to input identification codes from said terminal device, said server device is made to execute said second function and thereby made to confirm that identification codes that have been input are identification codes of all or part of said n companies, and under a condition that a confirmation has been obtained, said server device is made to execute said third function and thereby made to provide said predetermined service to said user.

7. A method for providing additional services for products as set forth in claim 1, wherein:
as a service to be provided by the third function of the server device, a provision of a game, a provision of a quiz, or a provision of fortune-telling information to the terminal device that is operated by the user is carried out.

8. A system for providing additional services for products, which has functions of attaching added values to products that are distributed in a market and providing additional services based on the added values, the system is comprised of:
a first identification code generating device, which generates a first identification code,
a second identification code generating device, which generates a second identification code,
a first identification code attaching device, which attaches said first identification code to a product that is shipped by a first company,
a second identification code attaching device, which attaches said second identification code to a product that is shipped by a second company, and
a service providing device, which inputs two different types of identification code separately at a same time or at different times from a user, and upon confirming that one of identification codes that have been input is said first identification code and the other is said second identification code, provides a predetermined service to said user.

9. A system for providing additional services for products, which has functions of attaching added values to products that are distributed in a market and providing additional services based on the added values, the system is comprised of:
a first identification code generating device, which generates a first identification code,
a second identification code generating device, which generates a second identification code,
a first identification code attaching device, which attaches said first identification code to a product that is shipped by a first company,
a second identification code attaching device, which attaches said second identification code to a product that is shipped by a second company, and
a service providing device, which has functions of inputting an identification code from a user and confirming that an identification code that has been input is said first identification code or said second identification code, provides a service of a first attribute under a condition that one of either said first identification code or said second identification code has been input, and provides a service of a second attribute under a condition that both said first identification code and said second identification code have been input.

10. A system for providing additional services for products, which has functions of attaching added values to products that are distributed in a market and providing additional services based on the added values, the system is comprised of:
a first identification code generating device, which generates a first identification code,
a second identification code generating device, which generates a second identification code,
a first identification code attaching device, which attaches said first identification code to a product that is shipped by a first company,
a second identification code attaching device, which attaches said second identification code to a product that is shipped by a second company, and
a service providing device, which has functions of inputting an identification code from a user and confirming that an identification code that has been input is said first identification code or said second identification code, provides a service of a first attribute under a condition that said first identification code has been input, provides a service of a second attribute under a condition that said second identification code has been input, and provides a service of a third attribute under a condition that both said first identification code and said second identification code have been input.

11. A system for providing additional services for products as set forth in claim 8, wherein:
when both the first identification code and the second identification code have been input from a user, a content of the service provided by the service providing device is changed according to an order of input of the two types of identification code.

12. A system for providing additional services for products as set forth in claim 8, wherein:
a plurality of patterns are prepared for one of either or both the first identification code and the second identification code, and a content of the service provided by the service providing device is changed according to a pattern of an identification code that has been input.

13. A system for providing additional services for products as set forth in claim 8, wherein:
as a service to be provided by the service providing device, a provision of a game, a provision of a quiz, or a provision of fortune-telling information to the user is carried out.

14. A system for providing additional services for products as set forth in claim 8, wherein:
one of either or both the first identification code attaching device and the second identification code attaching device has a function of printing an identification code onto a package of a product to be shipped.

15. A system for providing additional services for products as set forth in claim 8, wherein:
one of either or both the first identification code attaching device and the second identification code attaching device has a function of adding an object, on which an identification code is printed, inside a package of a product to be shipped.

16. A system for providing additional services for products as set forth in claim 8, wherein:
the service providing device has a function of communicating with the first identification code generating device and the second identification code generating device and is arranged to perform a confirmation process concerning an input identification code by inquiring with the first identification code generating device and the second identification code generating device.

17. A system for providing additional services for products as set forth in claim 8, wherein:
the first identification code generating device and the second identification code generating device have functions of generating the first identification code and the function of generating the second identification code, respectively, based on a predetermined algorithm, and
the service providing device is arranged to perform a confirmation process concerning an input identification code based on said predetermined algorithm.

18. A system for providing additional services for products as set forth in claim 8, wherein:
the service providing device is made of a server device connected to a network and is arranged to input identification codes from terminal devices operated by users via the network and provide services to the terminal devices operated by said users via the network.
